(19) United States
(12) Patent Application Publication
(10) Pub. No.: US 2009/0070724 A1
(43) Pub. Date: Mar. 12, 2009

(54) INFORMATION PROCESSING DEVICE, METHOD OF CREATING POWER SUPPLY SYSTEM TREE AND PROGRAM OF THE SAME

(75) Inventor: Motochika Okano, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/176,726

(22) Filed: Jul. 21, 2008

(30) Foreign Application Priority Data
Sep. 10, 2007 (JP) 2007-234325

(51) Int. Cl. G06F 17/50

(52) U.S. Cl. 716/11

(57) ABSTRACT

According to one embodiment, an information processing device includes a registration section for registering terminals of a symbol diagrams to a library by associating a relationship of connections of each of a devices, an extraction section for extracting a hierarchical structure of a power supply system and the symbol diagrams, a connection section for connecting the terminals of the symbol diagrams on the basis of the extracted hierarchical structure of the power supply system and the registered relationship of connections of the symbol diagrams, and a creation section for creating a schematic diagram of a hierarchical structure by connecting the terminals of the symbol diagrams on the basis of the extracted hierarchical structure of the power supply system and the registered relationship of connections of the symbol diagrams.

### CROSS-REFERENCE TO RELATED APPLICATIONS

This application is based upon and claims the benefit of priority from Japanese Patent Application No. 2007-234325, filed Sep. 10, 2007, the entire contents of which are incorporated herein by reference.

### BACKGROUND

1. Field

One embodiment of the present invention relates to an information processing device capable of automatically creating a power supply system tree out of a circuit, and a method of creating a power supply system tree and a program of the same.

2. Description of the Related Art

Generally, in logic designing and the like of printed circuit boards (PCBs), CAD systems are used for creating circuit diagrams. Creation of a circuit diagram using a CAD system is performed in such a manner that: symbol diagrams (a diagram for simplistically showing a corresponding device by describing a part of or an entire of a terminal provided in a corresponding device with a predetermined figure) of devices comprising a circuit (e.g., CPU, memory, etc.) are preliminarily registered in a library; a designer (creator of a circuit diagram) extracts symbol diagrams of devices, which comprise the circuit being an object of creating a circuit diagram, from the library and places the symbol diagrams at desired locations on the circuit diagram; and the designer connects terminals of the devices described as the placed symbol diagrams with lines (nets) for indicating the relationship of connections of the devices.

Also, for example, Jpn. Pat. Appln. KOKAI Publication No. 2005-309753 discloses an art in which a power supply/ground circuit diagram is automatically created out of an already-made circuit diagram file.

According to the art of Jpn. Pat. Appln. KOKAI Publication No. 2005-309753, however, a value of a current flowing through a wiring channel of an object power supply is necessary to be understood for calculating a voltage drop value. That is to say, a sum of consumption currents of the respective elements driven in the power supply system has to be calculated. Furthermore, power supplies have tree structures in which a power source is distributed from a power supply source being an origin to various power supply systems. In order to know a value of current flowing through a wiring channel of an upper power supply, a lower power supply distributed from the same power supply need to be known. However, power supply systems have become complicated that they straddle a plurality of circuit diagrams, and it has become difficult to grasp entire systems with human sense since conventional circuit diagrams and layout data are poor in recognizability. Furthermore, a power supply system tree cannot be automatically created out of a circuit diagram.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic diagram showing a sketch of a network system including a server computer 18.

FIG. 2 is an exemplary block diagram showing a functional configuration of the server computer 18.

FIG. 3 is an exemplary net relationship diagram of a multipin part (a part of a circuit diagram).

FIG. 4 is an exemplary net relationship diagram of a two-pin part.

FIG. 5 is an exemplary flow chart showing a method of creating a power supply system tree to which an information processing device of the present invention is applied.

FIG. 6 is an exemplary schematic diagram showing an example of a tree structure.

FIG. 7 is an exemplary figure showing an edit screen of a part.

FIG. 8 is an exemplary schematic diagram showing relationships between objects, logical coordinates, and grid coordinates.

FIG. 9 is an exemplary schematic diagram showing control processes and coordinate conversions.

FIG. 10 is an exemplary schematic diagram showing an example of a tree structure.

### DETAILED DESCRIPTION

Various embodiments according to the invention will be described hereinafter with reference to the accompanying drawings. In general, according to one embodiment of the invention, an information processing device having a library in which symbol information indicating symbol diagrams of arbitrary devices is registered, wherein the symbol information of devices, which comprise a circuit being an object of creating a circuit diagram, is taken out from the library, and the symbol diagrams indicated by the symbol information are placed at desired locations, for supporting a creation of a circuit diagram, comprising: a registration section for registering terminals of the symbol diagrams to the library by associating a relationship of connections of each of the devices; an extraction section for extracting a hierarchical structure of a power supply system and the symbol diagrams; a connection section for connecting the terminals of the symbol diagrams on the basis of the extracted hierarchical structure of the power supply system and the registered relationship of connections of the symbol diagrams; and a creation section for creating a schematic diagram of a hierarchical structure by connecting the terminals of the symbol diagrams on the basis of the extracted hierarchical structure of the power supply system and the registered relationship of connections of the symbol diagrams.

Now, an embodiment of the present invention will be explained with reference to accompanying drawings.

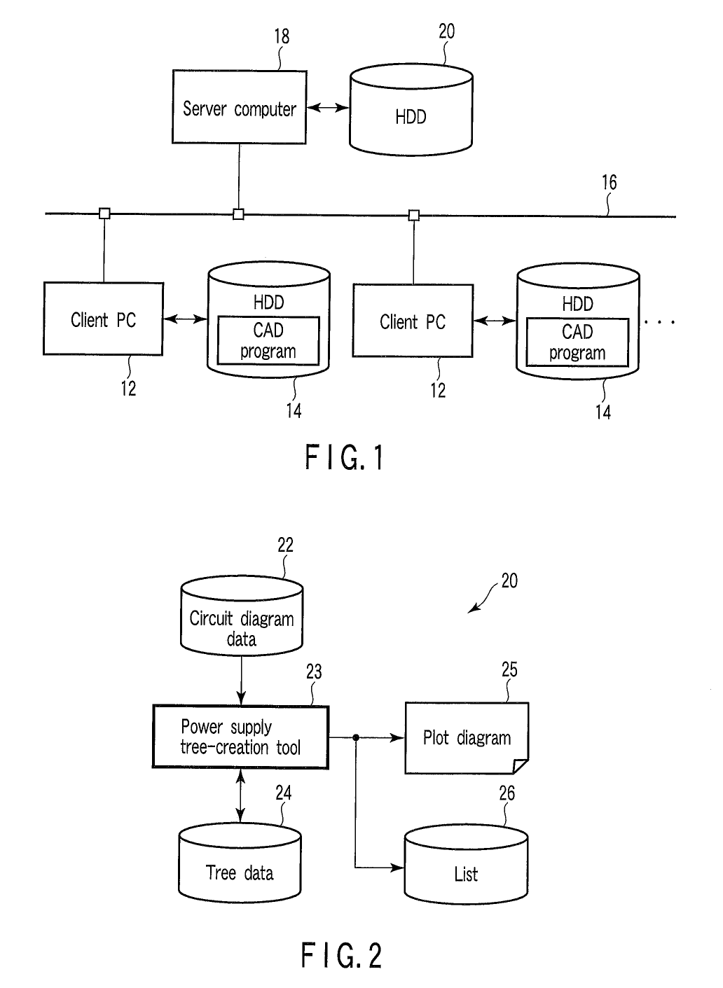

First, an information processing device according to one embodiment of the present invention will be explained with reference to FIGS. 1 and 2. This information processing device is realized as, for example, a server computer 18.

FIG. 1 is a schematic diagram showing a sketch of a network system including a server computer 18.

The network system includes a plurality of client PCs 12 that are operated by a creator of a circuit diagram during creation of a circuit diagram. The client PCs 12 consist of personal computers (PCs) and the like, and each of them are configured in such a manner that a CPU, a ROM, a RAM, an input/output port of which are connected to the network via a bus (not shown). A display device comprising a CRT and an LCD, and an input device comprising a keyboard, a mouse and the like are connected to the input/output port, and furthermore, the client PC 12 is connected to the network 16 such as the Ethernet® via a communication control device.

Also, an HDD (Hard Disk Drive) 14 is connected to (the input/output port of) the client PC 12, and a CAD program is preliminarily installed in the HDD 14. The CAD program is a program that realizes a CAD system for supporting creation of a circuit diagram performed by a circuit diagram designer, and this program is executed when the designer creates a circuit diagram.

Furthermore, a server computer 18 is connected to the network 16. The server computer 18 comprises computers such as a workstation, and it is configured in such a manner that a CPU, a ROM, a RAM, an input/output port of which are connected to the network via a bus (not shown). A display device comprising a CRT and an LCD, and an input device comprising a keyboard, a mouse and the like are connected to the input/output port, and furthermore, the server computer 18 is connected to the network 16 via the communication control device. Also, an HDD (library) 20 is connected to (the input/output port of) the server computer 18. In the HDD 20, circuit diagram data 22 (to be described later) being a parts library, tree data 24 (to be described later), (related) information on key parts, power consumption information on the symbol diagrams (key parts), etc., are stored, and a symbol diagram-adding program (a CAD program) is also preliminarily installed. The symbol diagram-adding program corresponds to a program for supporting creation of circuit diagrams disclosed in claim 9. The server computer 18, by executing the symbol diagram-adding program, functions as an information processing device which performs circuit diagram creation support disclosed in claim 1.

FIG. 2 is a block diagram showing a functional configuration of the server computer 18.

The server computer 18 has the following functions in the HDD 20: the circuit diagram data 22, the power supply system tree-creation tool (program) 23, the tree data 24, a plot diagram (creation function) 25, and a list 26.

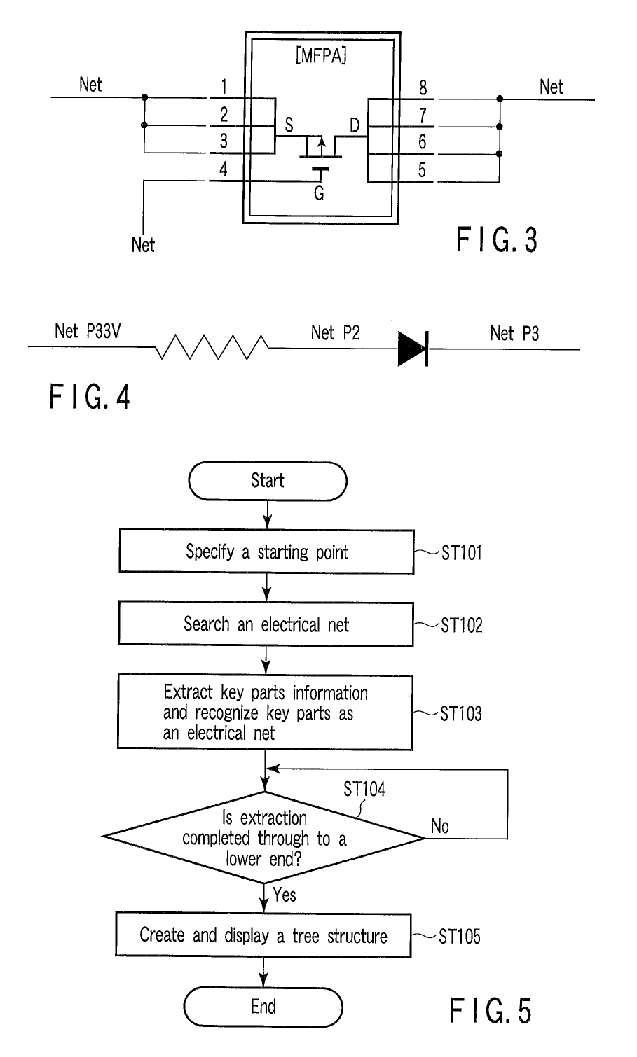

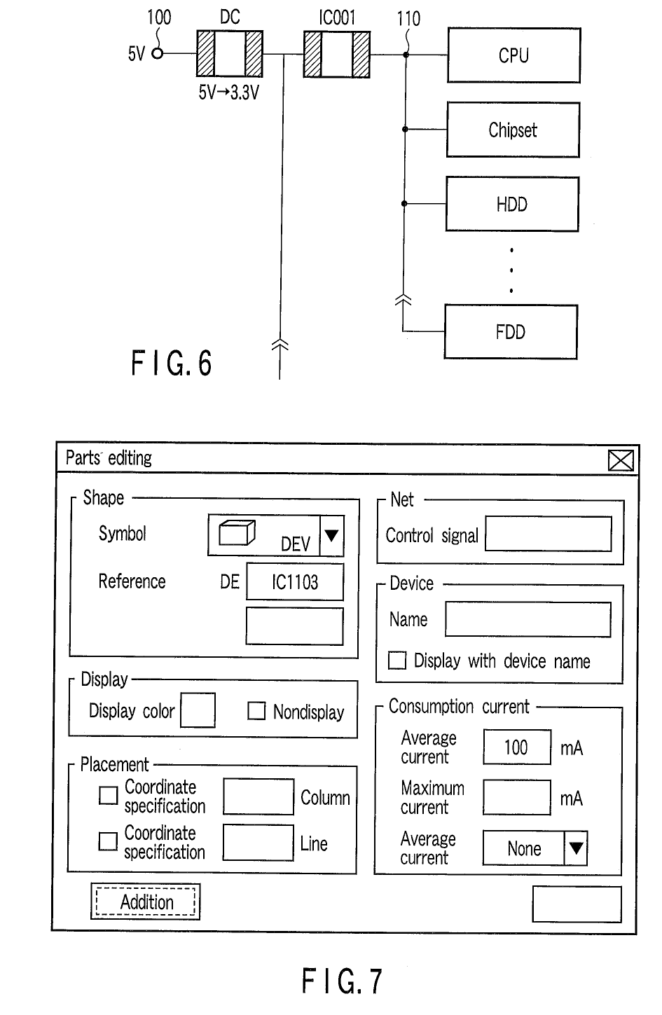

The circuit diagram data 22 is a database to be referred to when the client PC 12 performs creation of a circuit diagram by using the CAD system. Symbol information for indicating corresponding devices, which comprise (or there is possibility of comprising) a circuit being an object of creating a circuit diagram such as ICs and LSIs, as symbol diagrams to be displayed on the CAD system is preliminarily registered in the circuit diagram data 22. For instance, as shown in FIG. 3, information on a symbol diagram, which corresponds to a single device that is registered in the circuit diagram data 22, includes information such as an article code (e.g., “MFPA”) and connection information on each of the elements. An example of connection information is “Input pins 1-3 are connected to the upper net (electrical net), and the output pins 5-8 are connected to the lower net.” A net means a group of pins in a part to be connected. Each net is distinguished by being given a net name. As shown in FIG. 4, for example, in an electrical net having three nets (P33V, P2, P3), each of the nets is distinguished by the net names (P33V, P2, P3). Also, even in the same net, different net names are to be given on a circuit diagram, if resistance or filter is inserted therein (see FIG. 3). Therefore, in tracking a hierarchy of a power supply net, a net should be treated as the same net (electrical net) even when different net name are given due to insertion of resistance or filter. In the case of FIG. 3, for example, nets P33V, P2, and P3 are considered as one net being an electrical net. In other words, these three net names are combined for use. For instance, the three nets (P33V, P2, P3) are named generically as “PSV” 100 (see FIG. 6). As shown in FIG. 6, for example, PSV 100 which is a name of an upper net is used as a generic name of the entire net, but net names of lower nets such as P33V110 is not used.

Furthermore, symbol diagrams are also called as key parts. Key parts are parts for searching a lower power supply net from an upper power supply net. The key parts are registered in such a manner that a power supply net input to a particular input pin of a key part and a power supply net output from a particular output pin are associated. For example, in the case of FIG. 3, as is described above, a key part MFPA is registered by associating the following two nets: a power supply net A which is connected to input pins 1-3 of the key part MFPA being considered as an upper net; and a power supply net B which is connected to output pins 5-8 being considered as a lower net. Further, a net connected to a control pin 4 is considered as a control net. As for resistance parts, there is provided an option whether or not to consider resistance parts as key parts on the basis of rated values.

Key parts are used by reading a preliminarily created external file into the above-mentioned symbol diagram-adding program. As key parts information, for example, the following information is registered. Determination codes (identification information) are considered as article codes, and they are compared with property values of parts information in circuit diagram data, and codes corresponding with the property values are determined as key parts.

Article code

Number of input pins, and pin numbers

Number of output pins, and pin numbers

Number of control pins, and pin numbers

Next, the power supply system tree creation tool (program) 23 creates a tree structure (a schematic diagram comprising a hierarchy structure to be explained later, see FIGS. 6 and 10) out of a hierarchy structure and symbol diagrams of the extracted power supply system. The three data 24 stores data necessary for creating the tree structure (see FIGS. 6 and 10). The plot diagram (creation function) 25 is a function that outputs a plot diagram on an as needed basis. The list 26 is function that outputs a list of various data on an as needed basis.

Next, FIG. 5 is a flowchart indicating a method of creating a power supply system tree to which the information processing device of the present invention is applied.

First, the client PC 12 calls up the CAD program from the HDD 14, and accesses to the server computer 18 via the network 16. On the CAD program, the circuit diagram data and the like stored in the HDD 20 of the server computer 18 is read for placing necessary key parts, and a circuit diagram is thereby created and displayed on the CAD program (see FIG. 3). As shown in FIG. 6, a CPU, a chipset, an HDD, an FDD and the like are considered as key parts.

Next, the client PC 12 calls up the power supply system tree-creation tool 23 from the HDD 14. When an arbitrary point of the created circuit diagram is assigned as an origin (block S101), the power supply system tree-creation tool 23 performs a search for an electrical net from the assigned origin (block S102). The power supply system tree-creation tool 23 extracts a power supply net, key parts, main elements (pin elements, etc.) and the like by performing the search for the electrical net, and recognizes what are extracted as the electrical net (block S103). The power supply system tree-creation tool 23 reads information on the relationship of connections between the extracted power supply net (e.g., IC001 such as net name P33V110, etc., see FIG. 6), the key parts, main elements, etc., when the power supply system tree-creation tool 23 determines that extraction of the power supply net, the key parts, the main elements, etc. are completed all through to the lower level (YES of block S104). Then the power supply system tree-creation tool 23 creates and displays a tree structure on the basis of the read information on the relationship of connections (block S105, see FIGS. 6 and 10). For instance, as shown in FIG. 6, the key part “CPU” is preliminarily registered as information on the key part that is connected to a level below the key part “IC001”. Similarly, a key part “chipset” is preliminarily registered as information on the key part that is connected to the level below the key part “IC001”. Furthermore, the key part “IC001” is preliminarily registered as information on the key part that is connected to a level below a key part “DC”. By extracting these key parts, a hierarchy of the power supply net is converted to a tree structure.

Also, determination of an electrical net is performed by determining whether or not an electrical net is connected with a specific part. Determination parts are, as described above, registered by reading in an external file, and the following example of information is registered:

Parts category

Article code . . . omittable

Number of terminals

Pin pair . . . omittable

Then, an electrical net is determined based on the number of terminals. When a connection net has GND attribute, it is not considered an electrical net. Parts having 4 or more terminals require pin-pair information without exception.

In a case where:

Number of terminals=two . . . a net connected to each of the pins

In a case where:

Number of terminals=three . . . a net connected to two pins excluding GND pin (however, if there is no pin connected to GND, it is not applicable)

In a case where:

Number of terminals>three . . . a net connected to each of the pin-pairs registered to the pin-pair information.

As shown in FIG. 6, the created tree is, as a whole, considered as one net. Its net name is, for example, PSV. A net name of a lower level is not used. A tree display screen of the created tree structure is able to be variously controlled (enlarge, reduce, scroll) in the CAD program. Editing of the tree structure is also possible.

Furthermore, on the CAD program, as shown in FIG. 7 for example, setting of various attribute value to the power supply net, key parts, main elements can be performed.

Also, the CAD program includes the following functions:

Function of displaying and searching a list of the power supply net, key parts, main elements

Function of outputting the list of the power supply net, key parts, main elements (the list 26, FIG. 2)

Function of plot printing the tree structure (plot diagram (creation function) 25, FIG. 2)

Function of loading and storing the tree structure data.

Also, input/output files for the CAD program are as follows:

Circuit diagram data . . . input

Tree information data . . . input/output

List . . . output

Plot diagram . . . output

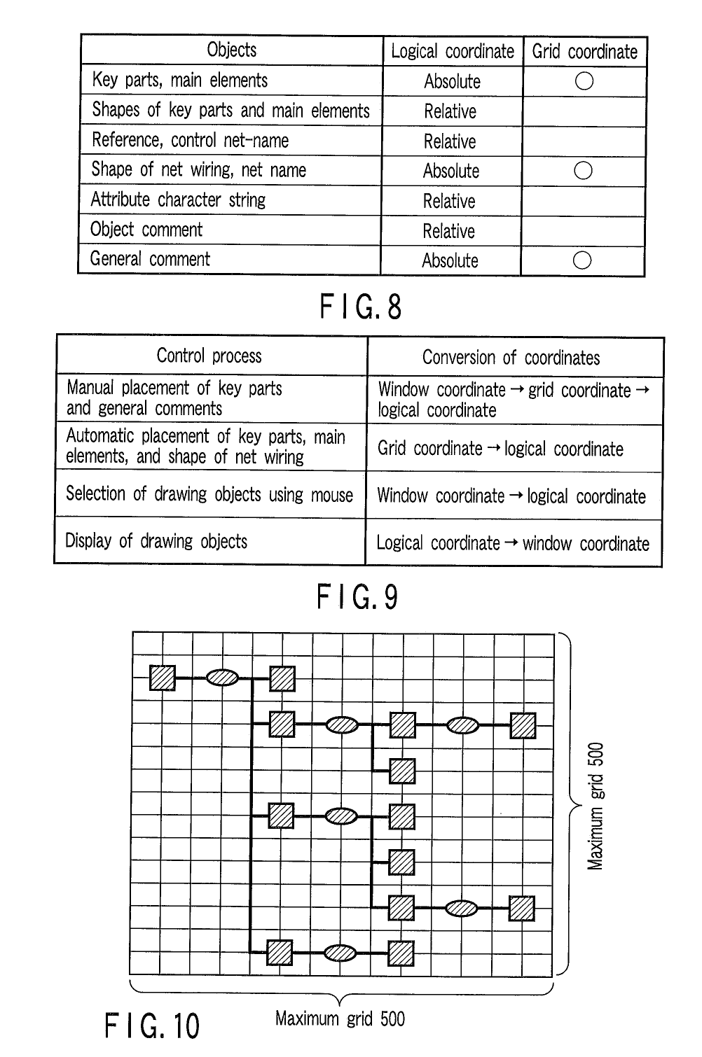

As shown in FIG. 10, when the created tree of the power supply system is displayed, besides theoretical coordinates, grid coordinates (see FIG. 10) is used for efficiently displaying a hierarchy structure of the power supply net in a tree-shaped structure. All of the key parts, net wiring (including net names), main elements are placed on the grid. Both of the X axis and Y axis of the grid start from 0, and spacing of the X axis and Y axis are variable and specified as parameters. Reference names and various attribute values to be displayed together with the key parts and main elements are not displayed on the grid, but on specific positions which depend on images of the key parts and main elements. These specific positions are defined with symbol shapes of the key parts and main elements. There are three types of coordinate systems, namely, a logical coordinate system, a grid coordinate system, a window coordinate system. All of the drawing objects (shapes of the key parts and main elements, shape of a net wiring, character strings) are managed with the logical coordinate. Also, the logical coordinate system is divided into an absolute coordinate and a relative coordinate according to types of the objects (see FIG. 8).

Conversion of a coordinate system in each control process is as follows. As for a relative coordinate, it is consequently converted from a logical coordinate of a parent object (see FIG. 9).

In the tree display screen, scroll bars are provided to both of the X and Y axes for making it possible to scroll the tree by using the scroll bars. A range of a scroll bar is fixed, and it does not depend on the key parts and main elements which are placed in accordance with the minimum value and maximum value of the grid coordinate.

These power supply trees interface with the loaded circuit diagram and layout diagram, and by pointing a cursor to the parts and net and selecting “Refer to the circuit diagram” or the like, the power supply trees work in conjunction with corresponding parts and net of the circuit diagram and layout diagram, and vice versa.

Also, it is easily possible to have arbitrary points of the tree structure as a starting point and an ending point and calculate power consumption (it is useful in calculating power drop value) of the enclosed predetermined region. Information on each of the key parts includes power consumption information, and summation of power consumption of the key parts applicable to the predetermined region is power consumption of the predetermined region. For example, in a case of a region having a starting point 100 (see FIG. 6) and an ending point (a key part in a lower level), power consumption is a summation of a CPU 150 mA+a chipset 200 mA+an HDD 180 mA+ . . . +an FDD 100 mA.

By using the present embodiment, it becomes possible to realize laborsaving in creating a power supply system tree out of a circuit diagram. In other words, it is possible to improve efficiency of wiring design of a power supply system, by expanding a hierarchy of a power supply system from key parts on the basis of a circuit diagram, and displaying the hierarchy of the power supply system and the main elements in a tree structure on a screen. Furthermore, it becomes possible to mange power consumption using a relationship diagram of these power supply systems, for applying the present embodiment to calculation of voltage drop value and power supply noise analysis.

Note that the present invention is not limited to the above-described embodiments as are, and structural requirements can be modified and materialized within a range which does not deviate from a gist of the present invention at the practical phase. Further, various inventions can be formed by appropriately combining the plurality of structural requirements which have been disclosed in the above-described embodiments. For example, several structural requirements may be eliminated from all of the structural requirements shown in the embodiments. Moreover, structural requirements over different embodiments may be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device having a library in which symbol information indicating symbol diagrams of arbitrary devices is registered, wherein the symbol information of devices, which comprise a circuit being an object of creating a circuit diagram, is taken out from the library, and the symbol diagrams indicated by the symbol information are placed at desired locations, for supporting a creation of a circuit diagram, comprising:
a registration section for registering terminals of the symbol diagrams to the library by associating a relationship of connections of each of the devices;
an extraction section for extracting a hierarchical structure of a power supply system and the symbol diagrams;
a connection section for connecting the terminals of the symbol diagrams on the basis of the extracted hierarchical structure of the power supply system and the registered relationship of connections of the symbol diagrams; and
a creation section for creating a schematic diagram of a hierarchical structure by connecting the terminals of the symbol diagrams on the basis of the extracted hierarchical structure of the power supply system and the registered relationship of connections of the symbol diagrams.

2. The information processing device according to claim 1, wherein
the symbol diagrams registered in the library are registered in such a manner that the symbol diagrams are associated with power consumption information, and, by designating a predetermined region in the schematic diagram of the hierarchical structure, the power consumption information of the symbol diagrams included in the region can be calculated.

3. The information processing device according to claim 1, wherein
the extraction section performs extraction until all of the hierarchical structure and the symbol diagrams of the power supply system are extracted.

4. The information processing device according to claim 1, wherein
when there are a plurality of net names in the schematic diagram of the hierarchical structure, a highest net name is used for naming the entire schematic diagram of the hierarchical structure.

5. A method of creating a power supply system tree wherein symbol information of device, which comprise a circuit being an object of creating a circuit diagram, is taken out from a library in which symbol information indicating symbol diagrams of arbitrary devices is registered, and the symbol diagrams indicated by the symbol information are arranged at desired locations, for supporting a creation of a circuit diagram, the method of creating a power supply system tree wherein
terminals of the symbol diagrams are registered to the library in such a manner that the symbol diagrams are associated with a relationship of connections of each of the devices,
a hierarchical structure of a power supply system and the symbol diagrams are extracted, and
the terminals of the symbol diagrams are connected on the basis of the extracted hierarchical structure of the power supply system and the registered relationship of connections of the symbol diagrams, for creating a schematic diagram of a hierarchical structure.

6. The method of creating power supply system tree according to claim 5, wherein
the symbol diagrams registered in the library are registered in such a manner that the symbol diagrams are associated with power consumption information, and, by designating a predetermined region in the schematic diagram of the hierarchical structure, the power consumption information of the symbol diagrams included in the region can be calculated.

7. The method of creating power supply system tree according to claim 5, wherein
the extraction is performed until all of the hierarchical structure and the symbol diagrams of the power supply system are extracted.

8. The method of creating power supply system tree according to claim 5, wherein
when there are a plurality of net names in the schematic diagram of the hierarchical structure, a highest net name is used for naming the entire schematic diagram of the hierarchical structure.

9. A recording media for recording a program used in an information processing device for supporting creation of a circuit diagram, wherein symbol information of devices, which comprise a circuit being an object of creating a circuit diagram, is taken out from a library in which symbol information indicating symbolic diagrams of arbitrary devices is registered, and the symbol diagrams indicated by the symbol information are arranged at desired locations, wherein the recorded program makes a computer execute:
registering terminals of the symbol diagrams in such a manner that the symbol diagrams are associated with a relationship of connections of each of the devices;
extracting a hierarchical structure of a power supply system and the symbol diagrams; and
connecting the terminals of the symbol diagrams on the basis of the extracted hierarchical structure of the power supply system and the registered relationship of connection of the symbol diagrams, and creating a schematic diagram of the hierarchical structure.
